(19) United States
(12) Patent Application Publication
(10) Pub. No.: US 2024/0242195 A1
(43) Pub. Date: Jul. 18, 2024

(54) INFORMATION PROCESSING APPARATUS, INFORMATION PROCESSING METHOD, AND NON-TRANSITORY COMPUTER READABLE MEDIUM

(71) Applicant: FUJIFILM BUSINESS INNOVATION CORP., Tokyo (JP)

(72) Inventor: Naoko SATO, Kanagawa (JP)

(73) Assignee: FUJIFILM BUSINESS INNOVATION CORP., Tokyo (JP)

(21) Appl. No.: 18/356,806

(22) Filed: Jul. 21, 2023

(30) Foreign Application Priority Data
Jan. 16, 2023 (JP) 2023-004715

(51) Int. Cl. G06Q 20/22; G06Q 30/0283

(52) U.S. Cl. CPC G06Q 20/227; G06Q 30/0283; G07F 17/266

(57) ABSTRACT

An information processing apparatus includes a processor configured to: calculate a fee as compensation for a product or service; and adjust, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

### CROSS-REFERENCE TO RELATED APPLICATIONS

This application is based on and claims priority under 35 USC 119 from Japanese Patent Application No. 2023-004715 filed Jan. 16, 2023.

### BACKGROUND

### (i) Technical Field

The present disclosure relates to an information processing apparatus, an information processing method, and a non-transitory computer readable medium.

### (ii) Related Art

Japanese Patent No. 4711811 discloses a photo sticker making device that, when processing a deposit of a monetary amount as compensation for taking a photograph, performs electronic money settlement in units of a predefined monetary amount which corresponds to the monetary value of one coin of a specific type.

Japanese Patent No. 6978897 discloses an information processing system which allows one or multiple payment methods to be selected as a payment method for settlement from among multiple payment methods at a multimedia terminal, and which enables a fee to be settled by the one or more selected payment methods.

### SUMMARY

Various settlement options are used when settling a fee as compensation for a product or service. Electronic money settlement using an IC card or the like may allow a fee to be settled in units of 1 yen, whereas cash settlement may only allow settlement in units of 10 yen in some cases. In such cases, if the electronic money balance is too low to pay the full amount of the fee and the remainder is in units of 1 yen, a situation may arise in which settlement is not possible even if the user attempts to settle the remainder with cash.

Aspects of non-limiting embodiments of the present disclosure relate to an information processing apparatus, an information processing method and a non-transitory computer-readable medium in which, when a first settlement option is insufficient to settle the full amount of a fee and the remainder is to be settled by a second settlement option, the fee may be settled using both the first and second settlement options, even if there is a limitation on the units of monetary value usable for settlement by the second settlement option.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided an information processing apparatus including a processor configured to: calculate a fee as compensation for a product or service; and adjust, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

### BRIEF DESCRIPTION OF THE DRAWINGS

An exemplary embodiment of the present disclosure will be described in detail based on the following figures, wherein:

FIG. 1 is a diagram illustrating a system configuration of an image forming system according to an exemplary embodiment of the present disclosure;

FIG. 2 is a diagram illustrating an example of a selection screen for selecting a payment method when paying a fee;

FIG. 3 is a selection screen example for a case in which fee settlement is completed and an operation for starting a printing process is performed;

FIG. 4 is a diagram illustrating an example of an operation screen of an image forming apparatus for a case of paying a balance due by a second settlement option, irrespective of the type of the second settlement option;

FIG. 5 is a block diagram illustrating a hardware configuration of an image forming apparatus according to an exemplary embodiment of the present disclosure;

FIG. 6 is a block diagram illustrating a functional configuration of an image forming apparatus according to an exemplary embodiment of the present disclosure;

FIG. 7 is a flowchart for explaining processing when using a print service or the like in an image forming apparatus according to an exemplary embodiment of the present disclosure;

FIG. 8 is a diagram illustrating an example of a selection screen for selecting a second settlement option for settling a balance due, that is, a remainder;

FIG. 9 is a flowchart for providing a detailed explanation of a process, described in step S106 of the flowchart in FIG. 7, for adjusting the monetary amount between first and second settlement options;

FIG. 10 is a diagram illustrating an example of a billing table stored in a data storage unit;

FIG. 11 is a flowchart for explaining operations by a control unit in a case of performing a process for adjusting the settlement amounts of settlement options in units of pages; and

FIG. 12 is a diagram illustrating an example of a selection screen for selecting a second settlement option in a case in which a process has been performed to adjust the settlement amounts of settlement options in units of pages.

### DETAILED DESCRIPTION

Next, an exemplary embodiment of the present disclosure will be described in detail and with reference to the drawings.

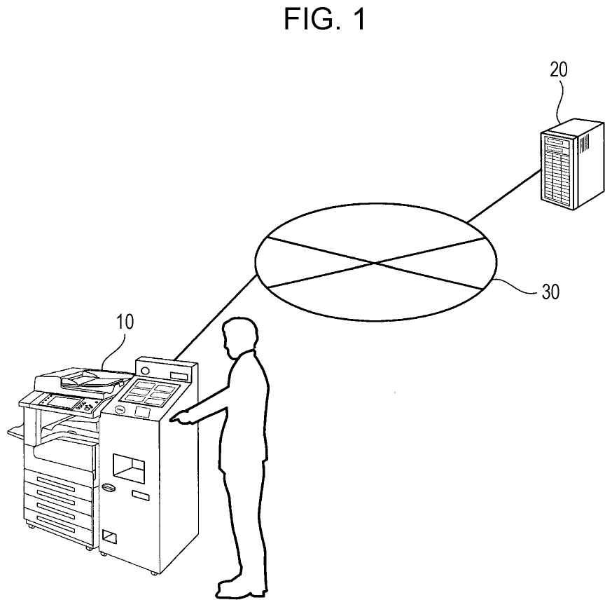

FIG. 1 is a diagram illustrating a configuration of an image forming system according to an exemplary embodiment of the present disclosure.

An image forming system according to an exemplary embodiment of the present disclosure includes an image forming apparatus 10 and a billing server 20 connected over the Internet 30. The image forming apparatus 10 is an apparatus referred to as a multi-function device, and includes multiple functions such as a print function, a scan function, a copy function, and a facsimile function using plain paper. The image forming apparatus 10 is installed in an environment usable by anyone, including, for example, a store such as a convenience store or supermarket, or a public facility such as a library. When a user uses such an image forming apparatus 10, the user is able to use various services such as copying, scanning, and printing by paying a fee.

Note that when using a service provided by the image forming apparatus 10, the monetary amount of a fee for executing the service is calculated in advance, after which a settlement option for paying the fee is selected from among multiple settlement options, such as settlement by a QR Code® or other two-dimensional code, settlement by an IC card, or cash settlement, and a process such as printing is executed after the fee settlement is completed.

At this point, if settlement by a two-dimensional code is selected, the image forming apparatus 10 transmits monetary amount information relevant for settlement to the billing server 20 and displays a two-dimensional code containing address information for the billing server 20 on an operation screen. The user captures an image of the two-dimensional code with a smartphone or other portable terminal device and accesses the billing server 20 to execute a fee settlement process. Thereafter, a notification indicating that fee settlement is completed is transmitted from the billing server 20 to the image forming apparatus 10, and the image forming apparatus 10 executes the print service or the like.

In the case of settlement using an IC card, the fee may be settled by electronic money using, for instance, a prepaid card issued at a university or the like, a prepaid card usable at convenience stores and the like, or a transportation IC card. Furthermore, in the case of cash settlement, the fee may be settled by inserting one or more coins into a cash acceptor. However, in the image forming apparatus 10 according to the exemplary embodiment, the cash acceptor is described as a device which does not support 1 yen coins and only allows for settlement in units of 10 yen.

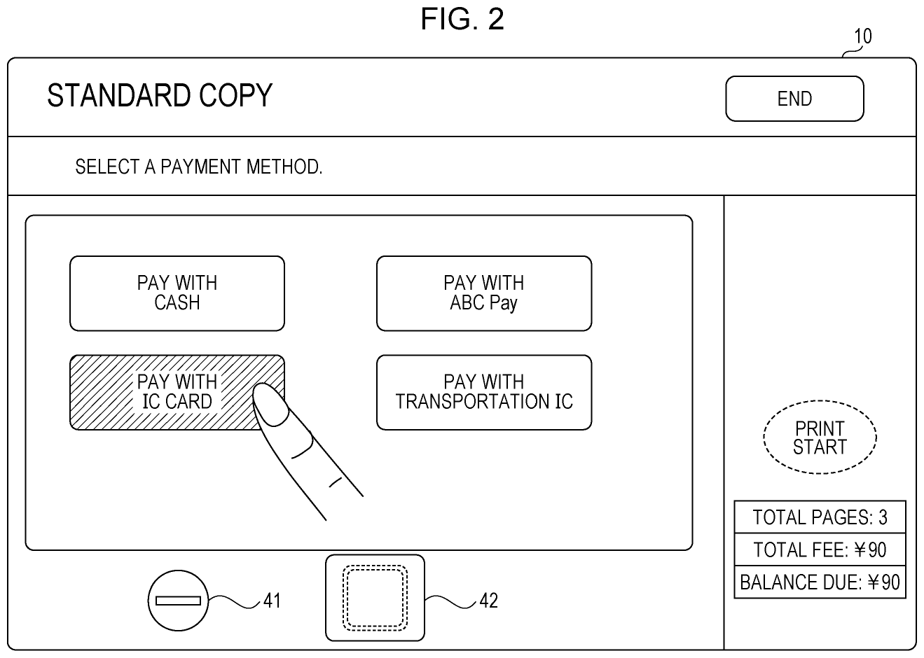

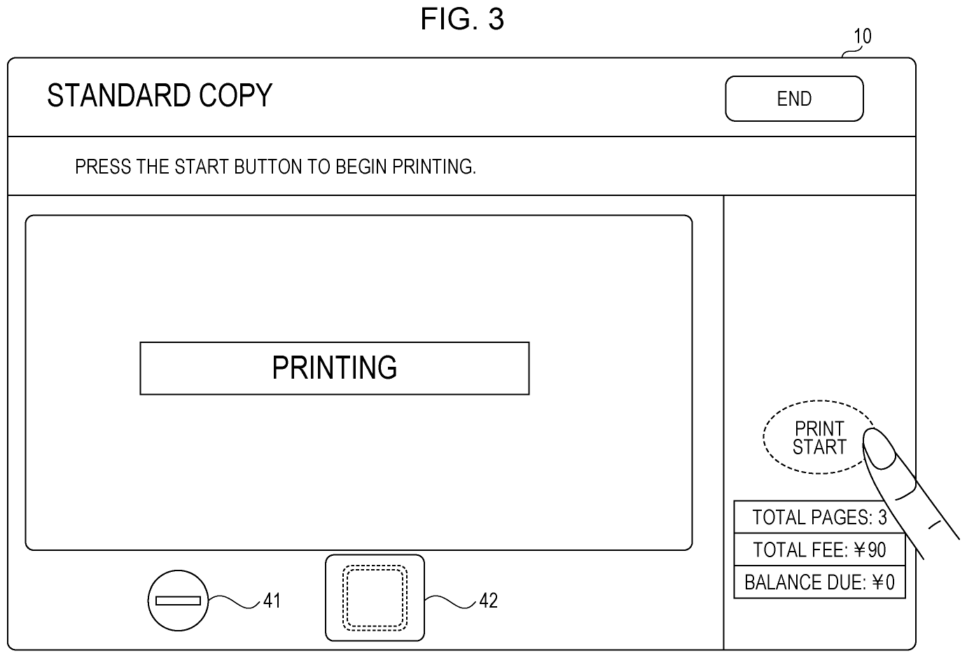

Examples of operation screens when using such an image forming apparatus 10 are illustrated in FIGS. 2 and 3.

FIG. 2 illustrates an example of a selection screen for selecting a payment method when paying a fee. As illustrated in FIG. 2, four operation buttons labeled “Pay with cash”, “Pay with IC card”, “Pay with ABC Pay”, and “Pay with transportation IC” are displayed on the operation screen of a touch panel. The user selects a settlement option to use for settlement from among the four operation buttons to pay the fee. As an example, FIG. 2 illustrates the case in which the user has selected the operation button labeled “Pay with IC card”. Also, in FIG. 2, three black and white copies are to be produced at a cost of 30 yen per page, for a total fee of 90 yen.

In addition, as illustrated in FIG. 2, a cash acceptor slot 41 and an IC card reader 42 are provided on the image forming apparatus 10. The user is able to settle payment in cash by inserting cash into the cash acceptor slot 41. The user is also able to settle payment with a pre-charged IC card or transportation IC card by holding up the IC card to the IC card reader 42.

If fee settlement is completed in this way, an operation button labeled “Print Start” is made operable, as illustrated in FIG. 3. A printing process is executed in response to the user touching the operation button labeled “Print Start”.

At this point, even if settlement by IC card is selected, for example, it may not be possible to pay the full amount of the fee if the charge balance on the IC card is low. Accordingly, in the image forming apparatus 10 according to the exemplary embodiment, the user is able to select another, second settlement option different from the first settlement option that was selected initially, thereby enabling the user to pay the balance due via the newly selected second settlement option.

However, in the image forming apparatus 10 according to the exemplary embodiment, although fee settlement in units of 1 yen is possible when settling with electronic money using an IC card or the like, settlement is only possible in units of 10 yen when settling with cash, as described above.

For this reason, if the system is designed to simply pay the balance due with the second settlement option, but the electronic money balance is too low to pay the full amount of the fee and the balance due is in units of 1 yen, a situation may arise in which settlement is not possible even if the user attempts to settle the balance due with cash.

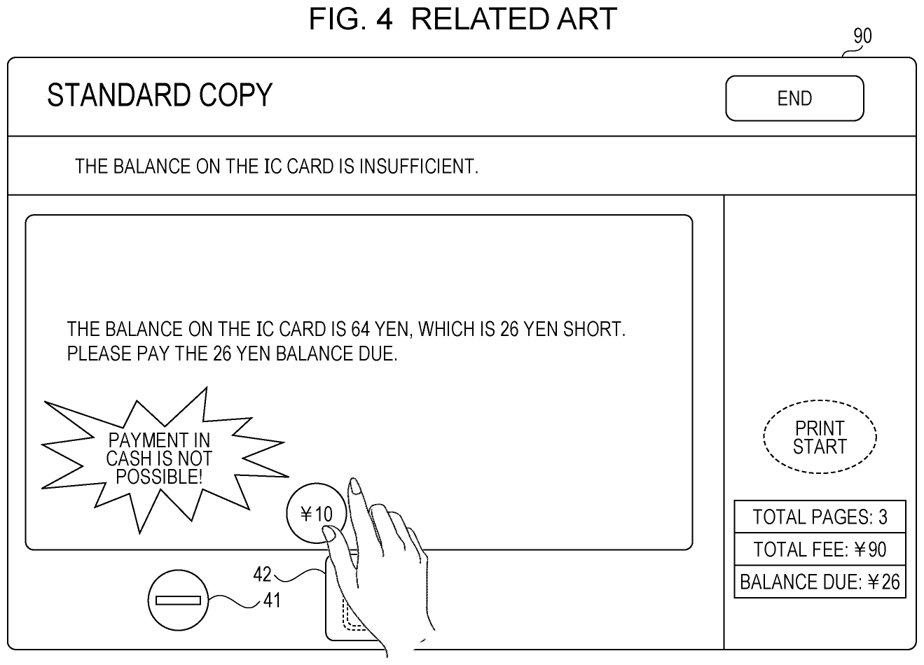

As an example, FIG. 4 illustrates an operation screen of an image forming apparatus 90 for the case of paying a balance due by a second settlement option, irrespective of the type of the second settlement option.

FIG. 4 is used to describe an example in which three black and white copies are to be produced at a cost of 30 yen per page, for a total fee of 90 yen, and even though payment by IC card is selected, the charge balance on the IC card is 64 yen. In other words, after subtracting 64 yen from 90 yen, 26 yen remains as the balance due.

Additionally, FIG. 4 illustrates the case in which the user has selected cash settlement as the second settlement option for paying the balance due. In a case like this, since the cash settlement that the user has selected as the second settlement option only allows for settlement in units of 10 yen, a situation arises in which the user is unable to pay the 26 yen of the balance due.

Accordingly, in the image forming apparatus 10 according to the exemplary embodiment, by performing processing like that described below, when the first settlement option is insufficient to settle the full amount of a fee and the remainder, that is, the balance due, is to be settled by the second settlement option, the fee may be settled using both the first and second settlement options, even if there is a limitation on the units of monetary value usable for settlement by the second settlement option.

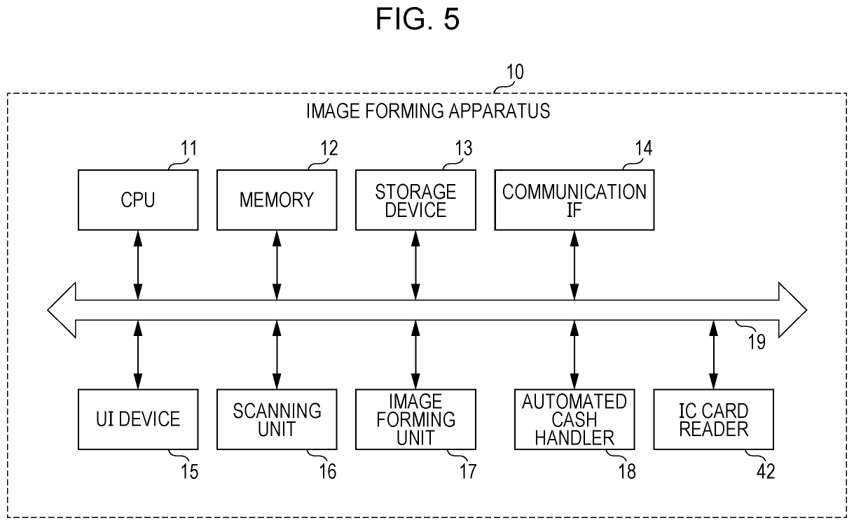

First, a hardware configuration of the image forming apparatus 10 according to the exemplary embodiment is illustrated in FIG. 5.

As illustrated in FIG. 5, the image forming apparatus 10 includes a CPU 11, a memory 12, a hard disk drive (HDD) or other storage device 13, a communication interface (IF) 14 that transmits and receives data with the billing server 20, another external apparatus, and the like over the Internet 30, a touch panel or other user interface (UI) device 15, a scanning unit 16, an image forming unit 17, an automated cash handler 18, and an IC card reader 42. These components are interconnected through a control bus 19.

The CPU 11 is a processor that controls operations by the image forming apparatus 10 by executing predetermined processing on the basis of a control program stored in the memory 12 or the storage device 13. Note that although the CPU 11 is described as reading out and executing a control program stored in the memory 12 or the storage device 13 in the exemplary embodiment, the control program is not limited thereto. The control program may also be provided by being recorded onto a computer-readable recording medium. For example, the program may be provided by being recorded on an optical disc, such as a Compact Disc Read-Only Memory (CD-ROM) or a Digital Versatile Disc Read-Only Memory (DVD-ROM), or by being recorded on a semiconductor memory, such as Universal Serial Bus (USB) memory or a memory card. Additionally, the control program may also be acquired from an external apparatus over a communication channel connected to the communication interface 14.

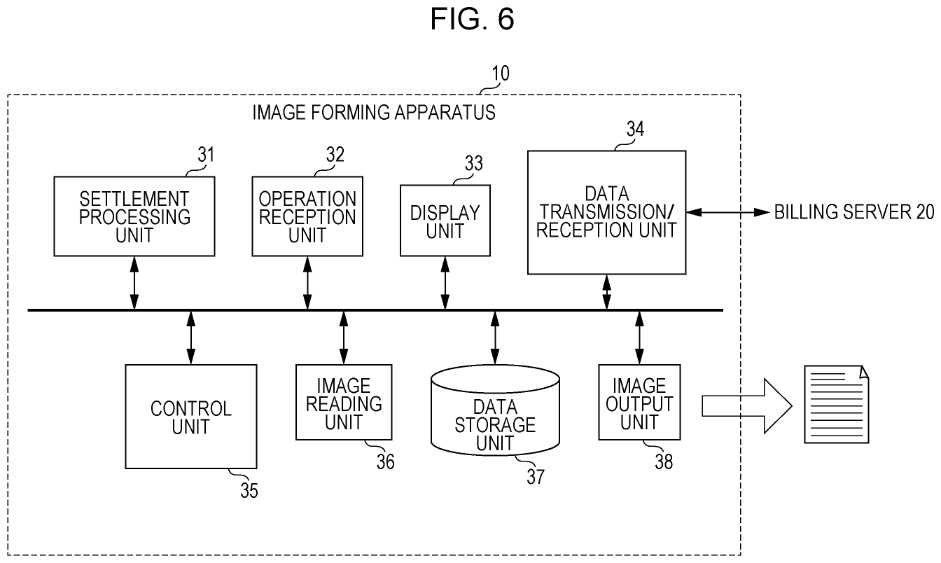

FIG. 6 is a block diagram illustrating a functional configuration of the image forming apparatus 10 achieved by executing the above control program.

As illustrated in FIG. 6, the image forming apparatus 10 according to the exemplary embodiment is provided with a settlement processing unit 31, an operation reception unit 32, a display unit 33, a data transmission-reception unit 34, a control unit 35, an image reading unit 36, a data storage unit 37, and an image output unit 38.

The data transmission-reception unit 34 transmits and receives data to and from an external apparatus such as the billing server 20.

The display unit 33 is controlled by the control unit 35 to display various information to a user. The operation reception unit 32 receives various operations from the user with respect to the image forming apparatus 10. Note that in the exemplary embodiment, a touch panel is formed by the display unit 33 and the operation reception unit 32 described above.

Additionally, the control unit 35 controls the image reading unit 36 and the image output unit 38 to execute various services such as printing, copying, and scanning. The data storage unit 37 stores various data, such as print data generated by the control unit 35. The data storage unit 37 also stores a billing table in which unit fees for various services are set for each service, and information about the units of payment available for each settlement option.

The image output unit 38, under control by the control unit 35, outputs an image on a recording medium such as printing paper. The image reading unit 36, under control by the control unit 35, reads an original document image from a placed original document.

In addition, the settlement processing unit 31 carries out a function for settling a fee as compensation for a service provided to the user.

When the execution of a service such as copying or printing is selected by the user, the control unit 35 calculates a fee as compensation for the service.

Additionally, if settlement by a first settlement option selected initially is insufficient to settle the full amount of the calculated fee, the monetary amount to be settled by the first settlement option and the monetary amount to be settled by a second settlement option different from the first settlement option are adjusted so that the monetary amount to be settled by the second settlement option is in units acceptable for settlement by the second settlement option.

Specifically, the control unit 35 calculates a remainder, that is, the balance due, by subtracting the maximum monetary amount settleable by the first settlement option from the calculated fee, and if the remainder is a monetary amount that is settleable in units acceptable for settlement by the second settlement option, the monetary amount to be settled by the first settlement option is set to the maximum monetary amount settleable by the first settlement option, and the monetary amount to be settled by the second settlement option is set to the remainder.

If the remainder is a monetary amount that is not settleable in units acceptable for settlement by the second settlement option, the remainder is rounded up in units acceptable for settlement by the second settlement option to set the monetary amount to be settled by the second settlement option, and the monetary amount that remains after subtracting the monetary amount to be settled by the second settlement option from the calculated fee is set as the monetary amount to be settled by the first settlement option.

Furthermore, if the unit fee per unit of service is different between the case of settling by the first settlement option and the case of settling by the second settlement option, the control unit 35 may set the fee for a number of units settleable by the first settlement option as the monetary amount to be settled by the first settlement option, and set the fee for the number of units not settled by the first settlement option as the monetary amount to be settled by the second settlement option.

In this case, if the unit fee in the case of settling by the first settlement option is lower than the unit fee in the case of settling by the second settlement option, the control unit 35 may set the fee for the maximum number of units settleable by the first settlement option as the monetary amount to be settled by the first settlement option.

Additionally, the control unit 35 displays, on the display unit 33, the settlement amounts for each of the first and second settlement options for each combination of settlement options when the first settlement option is combined with each of multiple second settlement options.

Next, operations by the image forming apparatus 10 according to the exemplary embodiment will be described in detail with reference to the drawings.

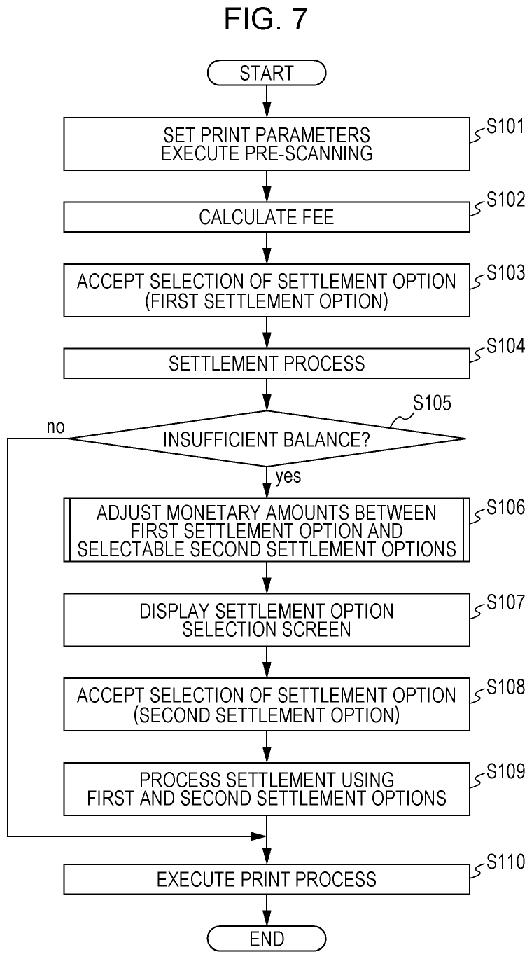

First, the processing when using a print service or the like in the image forming apparatus 10 according to the exemplary embodiment will be described with reference to the flowchart in FIG. 7.

First, in step S101, the control unit 35 sets print parameters, such as the number of copies, the paper size, and black and white/color printing by receiving user operations on the operation reception unit 32. Additionally, the control unit 35 controls the image reading unit 36 to execute pre-scanning to read a placed original document.

Next, in step S102, the control unit 35 calculates a fee for the service that the user is attempting to execute. For example, if the unit fee for black and white copying is 30 yen per page and the user is attempting to produce three black and white copies, the control unit 35 calculates 90 yen as the fee.

Additionally, through step S103, the control unit 35 displays an operation screen like the one illustrated in FIG. 2 on the display unit 33 and receives the selection of a settlement option for settling the calculated fee. The settlement option selected at this point is the first settlement option.

In step S104, the control unit 35 executes a settlement process by instructing the settlement processing unit 31 to settle the fee with the first settlement option selected by the user.

Next, in step S105, the control unit 35 determines whether the settlement processing unit 31 has completed settlement of the fee by the first settlement option, or whether settlement was not completed due to insufficient balance.

If it is determined in step S105 that fee settlement was completed without an insufficient balance, in step S110, the control unit 35 executes the printing process designated by the user.

However, if it is determined in step S105 that an insufficient balance has occurred, in step S106, the control unit 35 adjusts the monetary amounts between the first settlement option and a selectable, second settlement option other than the first settlement option. Specifically, the control unit 35 executes the adjustment so that the total of the monetary amount to be settled by the first settlement option and the monetary amount to be settled by the second settlement option matches the full amount of the fee for using the service.

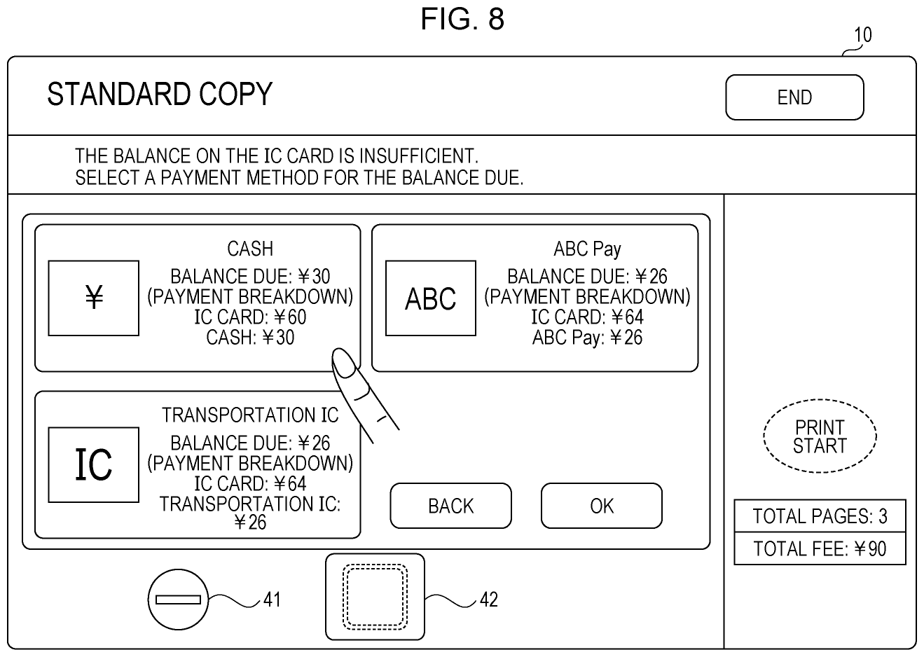

In step S107, the control unit 35 displays, on the display unit 33, a selection screen for selecting a second settlement option for settling the balance due, that is, the remainder. An example of the second settlement option selection screen displayed in this way is illustrated in FIG. 8. As illustrated in FIG. 8, the control unit 35 displays, on the display unit 33, the settlement amounts for each of the first and second settlement options for each combination of settlement options when the first settlement option is combined with each of multiple second settlement options.

For example, if the second settlement option is cash, the monetary amount to be settled by an IC card is 60 yen and the monetary amount to be settled with cash is 30 yen, for a total of 90 yen. If the second settlement option is a transportation IC, the monetary amount to be settled by an IC card is 64 yen and the monetary amount to be settled with the transportation IC is 26 yen, for a total of 90 yen. If the second settlement option is two-dimensional code settlement such as ABC Pay, the monetary amount to be settled by an IC card is 64 yen and the monetary amount to be settled by two-dimensional code settlement is 26 yen, for a total of 90 yen.

Referring to FIG. 8, if cash is selected as the second settlement option, the settlement amount of the IC card is set to 60 yen even though the IC card has a charge balance of 64 yen, so that the cash settlement amount is 30 yen. This is because the units of settlement by cash are in units of 10 yen, and thus the monetary amounts are adjusted so that the user is able to settle the full fee amount of 90 yen by paying 30 yen in cash.

Conversely, if settlement by a transportation IC that allows settlement in units of 1 yen or settlement by ABC Pay is selected as the second settlement option, the maximum amount of 64 yen settleable with the first settlement option, namely the IC card, is set as the monetary amount to be settled by the first settlement option, and the remainder of 26 yen is set as the monetary amount to be settled by the second settlement option.

Returning to FIG. 7 to continue the description, in step S108, the control unit 35 receives the selection of the second settlement option on the basis of a user operation.

In step S109, the control unit 35 executes a settlement process by instructing the settlement processing unit 31 to settle the fee as compensation for the service by combining the first settlement option with the second settlement option selected by the user.

Finally, when the fee settlement is completed in step S109, in step S110, the control unit 35 executes the printing process designated by the user.

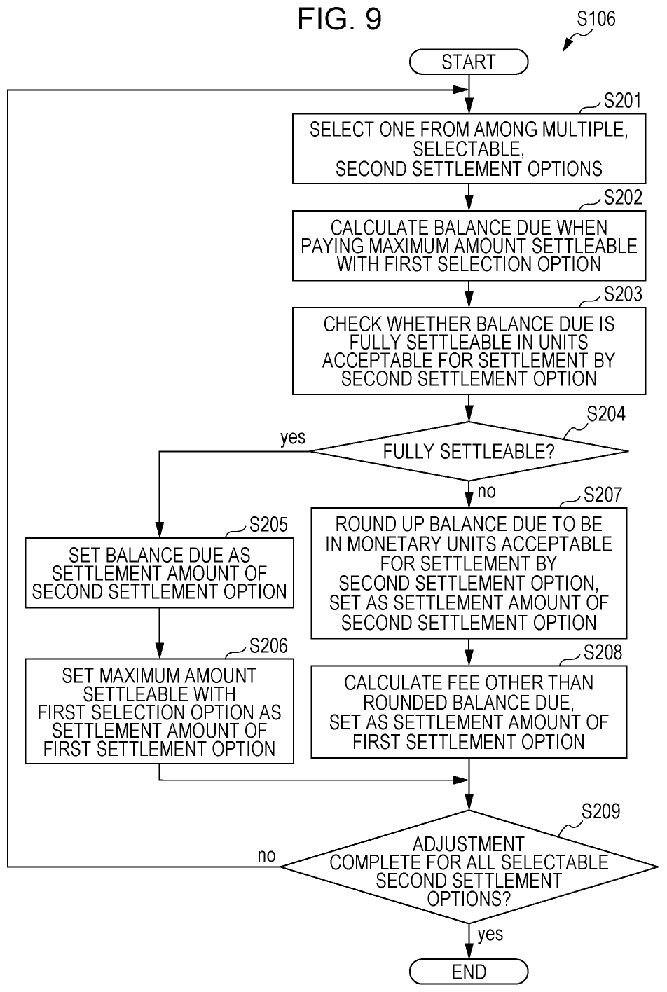

Next, the flowchart in FIG. 9 will be referenced to describe that details of the process, described in step S106 of the flowchart in FIG. 7, for adjusting the monetary amount between the first and second settlement options.

First, in step S201, the control unit 35 selects one settlement option from among the multiple, selectable, second settlement options. For example, in the case illustrated in FIG. 8, settlement by IC card likewise has already been selected as the first settlement option, and therefore one settlement option is selected from among the three settlement options of cash, transportation IC, and ABC Pay which are selectable as the second settlement option.

In step S202, the control unit 35 calculates, as the balance due, the remainder in the case of paying the maximum amount settleable with the first settlement option. For example, in the example illustrated in FIG. 8, the maximum amount settleable by the first settlement option, namely the IC card, is 64 yen, and therefore the remaining 26 yen of the 90 yen fee is calculated as the balance due.

Next, in step S203, the control unit 35 checks whether the calculated balance due is fully settleable in units acceptable for settlement by the second settlement option. For example, if cash is selected as the second settlement option, the control unit 35 determines that the 26 yen is not settleable, because cash settlement is in units of 10 yen. If a transportation IC or ABC Pay is selected as the second settlement option, the control unit 35 determines that the 26 yen is fully settleable.

In step S204, if the control unit 35 has determined that the balance due is fully settleable by the second settlement option, in step S205, the control unit 35 sets the balance due as the settlement amount of the second settlement option. Additionally, in step S206, the control unit 35 sets the maximum amount settleable with the first settlement option as the settlement amount of the first settlement option.

For example, if the second settlement option is a transportation IC or ABC Pay, the control unit 35 sets the 26 yen balance due as the settlement amount of the second settlement option. The control unit 35 also sets the maximum amount of 64 yen settleable by the first settlement option, namely the IC card, as the settlement amount of the first settlement option.

In step S204, if the control unit 35 has determined that the balance due is not fully settleable by the second settlement option, in step S207, the control unit 35 rounds up the balance due to be in monetary units acceptable for settlement by the second settlement option, and sets the rounded amount as the settlement amount of the second settlement option.

For example, if the second settlement option is cash, the control unit 35 rounds up the 26 yen balance due to 30 yen to be in units of 10 yen, and sets 30 yen as the settlement amount of the second settlement option. Additionally, in step S208, the control unit 35 subtracts the settlement amount of 30 yen to be settled by the second settlement option from the full amount of the 90 yen fee to obtain 60 yen, and sets 60 yen as the settlement amount of the first settlement option.

The control unit 35 repeats the processing in steps S201 to S208 for each selectable second settlement option, and ends the processing upon determining in step S209 that the process of adjustment between the first settlement option and all selectable second settlement options is complete.

[Case in which fee schedule is different depending on settlement option] Note that in the description above, the fee is calculated according to the unit fee for the service to be used, irrespective of the settlement option. However, in some cases, the unit fee may change depending on the type of settlement option to be used for settlement.

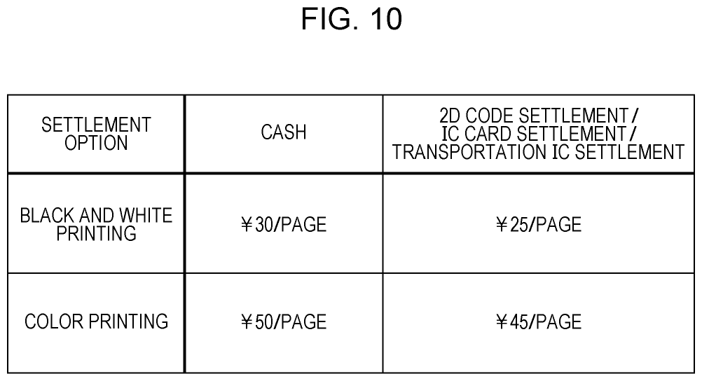

As an example, a case will be described in which the billing table stored in the data storage unit 37 is like the table illustrated in FIG. 10. In the billing table illustrated in FIG. 10, the fee for black and white printing is 30 yen per page when settling with cash and 25 yen per page when settling by two-dimensional code settlement, IC card settlement, or transportation IC settlement. Also, the fee for color printing is 50 yen per page when settling with cash and 45 yen per page when settling by two-dimensional code settlement, IC card settlement, or transportation IC settlement.

In situations in which the fee schedule is different depending on the type of settlement option in this way, problems may occur if the second settlement option is used to settle the remainder in cases in which the full amount of a fee is not successfully settled by the first settlement option due to insufficient balance.

An example will be described using a case in which the user attempts to make two color copies and settle the fee with an IC card having a balance of only 50 yen. In this case, since the user is attempting to use an IC card to settle the fee for two color copies, the unit fee is 45 yen/page, for a total fee of 90 yen. However, the balance on the IC is only 50 yen, which is 40 yen short. At this point, assume that the user selects cash as the second settlement option and pays the 40 yen balance due in cash.

For the first color copy, a fee of 45 yen is not a problem because the full amount is settled by the IC card, but for the second color copy, the fee is set to the unit fee for an IC card even though 40 yen out of the 45 yen is settled with cash and ends up being an almost entirely cash settlement. In other words, even though the unit fee is changed depending on the type of settlement option, cash is used to settle a fee based on the fee schedule for an IC card.

Accordingly, if the unit fee per unit of service is different between the case of settling by the first settlement option and the case of settling by the second settlement option, the control unit 35 sets the fee for a number of units, that is, a number of pages, settleable by the first settlement option as the monetary amount to be settled by the first settlement option, and sets the fee for the number of pages not settled by the first settlement option as the monetary amount to be settled by the second settlement option.

Note that if the unit fee in the case of settling by the first settlement option is lower than the unit fee in the case of settling by the second settlement option, the control unit 35 mayflower the amount to be paid by the user by simply setting the fee for the maximum number of pages settleable by the first settlement option as the monetary amount to be settled by the first settlement option.

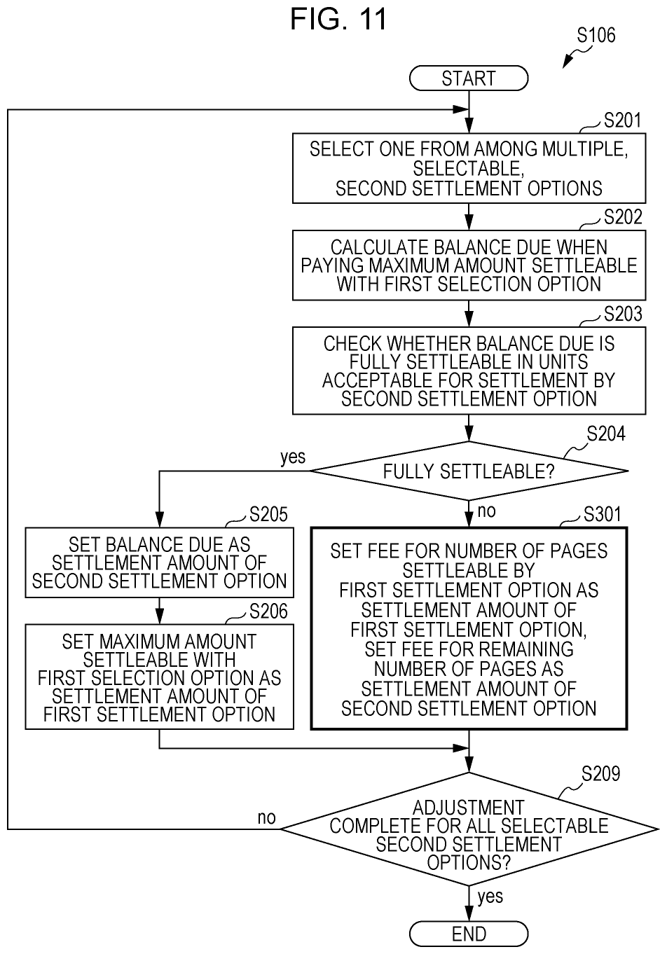

The flowchart in FIG. 11 will be referenced to describe operations by the control unit 35 in the case of performing a process for adjusting the settlement amounts of settlement options in units of pages in this way. Note that in the flowchart illustrated in FIG. 11, the processing in steps S207 and S208 of the flowchart illustrated in FIG. 9 is replaced by the processing in step S301, and therefore a description is reduced or omitted for the portions which are the same.

Note that the following description likewise assumes that the user selects settlement by an IC card as the first settlement option, and that the charge balance on the IC card is 64 yen.

If the control unit 35 has determined in step S204 that the balance due is not fully settleable by the second settlement option, in step S301, the control unit 35 sets the fee for a number of pages settleable by the first settlement option as the settlement amount of the first settlement option, and sets the fee for the remaining number of pages as the settlement amount of the second settlement option.

For example, if the second settlement option is cash, the control unit 35 sets the 45 yen fee for one page, which is settleable by the first settlement option, namely the IC card, as the settlement amount of the first settlement option. The control unit 35 sets the 50 yen fee for the remaining number of pages, namely one page, as the settlement amount of the second settlement option.

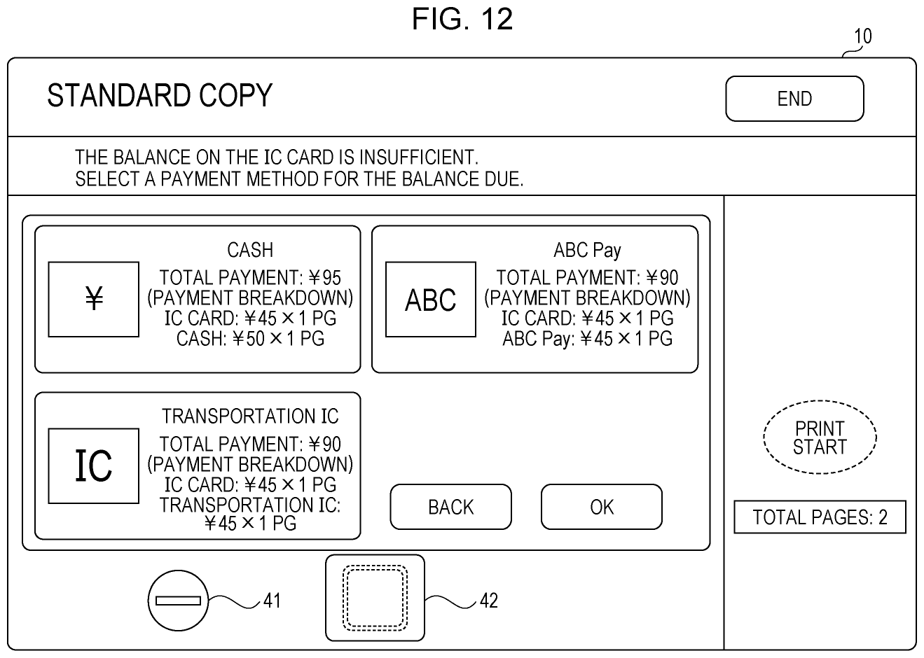

FIG. 12 illustrates an example of a selection screen for selecting the second settlement option, the screen being displayed on the display unit 33 by the control unit 35 after making such adjustments. As illustrated in FIG. 12, the control unit 35 displays, on the display unit 33, the settlement amounts for each of the first and second settlement options for each combination of settlement options when the first settlement option is combined with each of multiple second settlement options.

For example, if the second settlement option is cash, the monetary amount to be settled by an IC card is 45 yen and the monetary amount to be settled with cash is 50 yen, for a total of 95 yen. If the second settlement option is a transportation IC, the monetary amount to be settled by an IC card is 45 yen and the monetary amount to be settled with the transportation IC is 45 yen, for a total of 90 yen. If the second settlement option is two-dimensional code settlement such as ABC Pay, the monetary amount to be settled by an IC card is 45 yen and the monetary amount to be settled by two-dimensional code settlement is 45 yen, for a total of 90 yen.

In other words, by making such adjustments, the settlement options to be used to settle the fee are selectable on per-page basis, and even if the unit fees differ depending on the type of settlement option, it is possible to avoid a situation in which a fee based on the unit fee set for a certain settlement option is settled by a different settlement option.

In the exemplary embodiment above, the term “processor” refers to hardware in a broad sense. Examples of the processor include general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term “processor” is broad enough to encompass one processor or plural processors in collaboration which are located physically apart from each other but may work cooperatively. The order of operations of the processor is not limited to one described in the exemplary embodiment above, and may be changed.

### Exemplary Modifications

The exemplary embodiment above is described using the case of setting a fee charged for services provided by an image forming apparatus, but the present disclosure is not limited thereto, and the present disclosure may be applied similarly to any of various information processing apparatuses that settle fees as compensation for products or services, such as ticket vending machines that issue passenger tickets, admission tickets, or the like, and vending machines that sell various products such as canned beverages.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An information processing apparatus comprising a processor configured to:

calculate a fee as compensation for a product or service; and

adjust, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

(((2)))

The information processing apparatus according to (((1))), wherein the processor is configured to calculate a remainder by subtracting a maximum monetary amount settleable by the first settlement option from the calculated fee, and if the remainder is a monetary amount that is settleable in units acceptable for settlement by the second settlement option, the processor is configured to set the monetary amount to be settled by the first settlement option to the maximum monetary amount settleable by the first settlement option, and set the monetary amount to be settled by the second settlement option to the remainder.

(((3)))

The information processing apparatus according to (((2))), wherein if the remainder is a monetary amount that is not settleable in units acceptable for settlement by the second settlement option, the processor is configured to round up the remainder in units acceptable for settlement by the second settlement option to set the monetary amount to be settled by the second settlement option, and set the monetary amount that remains after subtracting the monetary amount to be settled by the second settlement option from the calculated fee as the monetary amount to be settled by the first settlement option.

(((4)))

The information processing apparatus according to any one of (((1))) to (((3))), wherein if a unit fee per unit of product or service is different between a case of settling by the first settlement option and a case of settling by the second settlement option, the processor is configured to set the fee for a number of units settleable by the first settlement option as the monetary amount to be settled by the first settlement option, and set the fee for the number of units not settled by the first settlement option as the monetary amount to be settled by the second settlement option.

(((5)))

The information processing apparatus according to (((4))), wherein if the unit fee in the case of settling by the first settlement option is lower than the unit fee in the case of settling by the second settlement option, the processor is configured to set the fee for a maximum number of units settleable by the first settlement option as the monetary amount to be settled by the first settlement option.

(((6)))

The information processing apparatus according to any one of (((1))) to (((5))), wherein the processor is configured to display the settlement amounts for each of the first and second settlement options for each combination of settlement options when the first settlement option is combined with each of a plurality of second settlement options.

(((7)))

A program causing a computer to execute a process comprising:

calculating a fee as compensation for a product or service; and

adjusting, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

What is claimed is:

1. An information processing apparatus comprising:
a processor configured to:
calculate a fee as compensation for a product or service; and
adjust, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

2. The information processing apparatus according to claim 1, wherein the processor is configured to calculate a remainder by subtracting a maximum monetary amount settleable by the first settlement option from the calculated fee, and if the remainder is a monetary amount that is settleable in units acceptable for settlement by the second settlement option, the processor is configured to set the monetary amount to be settled by the first settlement option to the maximum monetary amount settleable by the first settlement option, and set the monetary amount to be settled by the second settlement option to the remainder.

3. The information processing apparatus according to claim 2, wherein if the remainder is a monetary amount that is not settleable in units acceptable for settlement by the second settlement option, the processor is configured to round up the remainder in units acceptable for settlement by the second settlement option to set the monetary amount to be settled by the second settlement option, and set the monetary amount that remains after subtracting the monetary amount to be settled by the second settlement option from the calculated fee as the monetary amount to be settled by the first settlement option.

4. The information processing apparatus according to claim 1, wherein if a unit fee per unit of product or service is different between a case of settling by the first settlement option and a case of settling by the second settlement option, the processor is configured to set the fee for a number of units settleable by the first settlement option as the monetary amount to be settled by the first settlement option, and set the fee for the number of units not settled by the first settlement option as the monetary amount to be settled by the second settlement option.

5. The information processing apparatus according to claim 4, wherein if the unit fee in the case of settling by the first settlement option is lower than the unit fee in the case of settling by the second settlement option, the processor is configured to set the fee for a maximum number of units settleable by the first settlement option as the monetary amount to be settled by the first settlement option.

6. The information processing apparatus according to claim 1, wherein the processor is configured to display the settlement amounts for each of the first and second settlement options for each combination of settlement options when the first settlement option is combined with each of a plurality of second settlement options.

7. An information processing method comprising:
calculating a fee as compensation for a product or service; and
adjusting, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.

8. A non-transitory computer readable medium storing a program causing a computer to execute a process comprising:
calculating a fee as compensation for a product or service; and
adjusting, if settlement by a first settlement option selected initially is insufficient to settle a full amount of the calculated fee, a monetary amount to be settled by the first settlement option and a monetary amount to be settled by a second settlement option different from the first settlement option, so that the monetary amount to be settled by the second settlement option is in units acceptable for settlement by the second settlement option.
